(19) United States
(12) Patent Application Publication
(10) Pub. No.: US 2026/0079368 A1
(43) Pub. Date: Mar. 19, 2026

(54) DISPLAY PANEL

(71) Applicant: Guangzhou China Star Optoelectronics Semiconductor Display Technology Co., LTd., Guangzhou (CN)

(72) Inventor: Lihong GUI, Guangzhou (CN)

(73) Assignee: Guangzhou China Star Optoelectronics Semiconductor Display Technology Co., LTd., Guangzhou (CN)

(21) Appl. No.: 18/951,666

(22) Filed: Nov. 19, 2024

(30) Foreign Application Priority Data
Sep. 13, 2024 (CN) 202411291317.5

(51) Int. Cl. G02F 1/1343; G02F 1/1335; G02F 1/1362

(52) U.S. Cl. CPC G02F 1/134372; G02F 1/133514; G02F 1/134336; G02F 1/13439; G02F 1/133512; G02F 1/136286; G02F 2203/01

(57) ABSTRACT

A display panel includes a red sub-pixel, a green sub-pixel, and a blue sub-pixel. The transmittance of the blue sub-pixel is lower than that of the red sub-pixel and that of the green sub-pixel respectively. An average transmissive area is defined as an average value of the sum of the transmissive areas of the blue, red, and green sub-pixels. The transmissive area of the blue sub-pixel is less than the average transmissive area, the transmissive areas of the red and green sub-pixels are greater than or equal to the average transmissive area. The transmissive area of the red and the transmissive area of green sub-pixels are not simultaneously equal to the average transmissive area.

### CROSS-REFERENCE TO RELATED APPLICATION

This present disclosure claims priority to Chinese Patent Application No. 202411291317.5, filed on Sep. 13, 2024, the disclosure of which is incorporated herein by reference in its entirety.

### TECHNICAL FIELD

This present disclosure relates to display technologies.

### BACKGROUND

In a conventional liquid crystal display panel of Fringe Field Switching (FFS) display mode, a blue sub-pixel is generally designed to have an area equal to that of other color sub-pixels.

During the research and practical process in the prior art, it has been discovered that when Δnd<340 nm, the transmittance of the display panel decreases, resulting in a bluish appearance on an entire white picture. Herein, Δnd represents the multiplication result of the birefringence (Δn) of liquid crystal molecules and the thickness (d) of a liquid crystal layer.

### SUMMARY

In one or more embodiments of the present disclosure, a display panel includes an array substrate, a liquid crystal layer, and an opposed substrate arranged sequentially, the display panel further includes a color film layer. The color film layer includes a red sub-pixel, a green sub-pixel, and a blue sub-pixel. The transmittance of the blue sub-pixel is lower than that of the red sub-pixel and that of the green sub-pixel respectively, and an average transmissive area is defined as the average value of the sum of the transmissive area of one blue sub-pixel, the transmissive area of one red sub-pixel, and the transmissive area of one green sub-pixel. Herein, Δnd≤340 nm. Δnd represents the multiplication result of the birefringence of the liquid crystal molecules and the thickness of the liquid crystal layer. The transmissive area of the blue sub-pixel is less than the average transmissive area. The transmissive area of the red sub-pixel is greater than or equal to the average transmissive area. The transmissive area of the green sub-pixel is greater than or equal to the average transmissive area. The transmissive area of the red sub-pixel and the transmissive area of the green sub-pixel are not simultaneously equal to the average transmissive area.

In one or more embodiments of the present disclosure, a display panel includes a red sub-pixel, a green sub-pixel, and a blue sub-pixel. The transmittance of the blue sub-pixel is lower than that of the red sub-pixel and that of the green sub-pixel respectively. An average transmissive area is defined as an average value of the sum of the transmissive areas of one blue sub-pixel, one red sub-pixel, and one green sub-pixel. Herein, Δnd<320 nm. The transmissive area of the blue sub-pixel is less than the average transmissive area. The transmissive area of the red sub-pixel and the transmissive area of the transmissive area of green sub-pixel are both greater than or equal to the average transmissive area. The sum of the transmissive areas of one red sub-pixel and one green sub-pixel is greater than twice the average transmissive area.

### BRIEF DESCRIPTION OF THE DRAWINGS

FIG. 1 is a schematic cross-sectional view of the display panel according to one or more embodiments of the present disclosure.

FIG. 2 is a schematic top view of the display panel according to one or more embodiments of the present disclosure.

FIG. 3 is a schematic top view of the opposed substrate corresponding to FIG. 2.

FIG. 4 is a schematic top view of the array substrate corresponding to FIG. 2.

FIG. 5 is a schematic top view of the first pixel electrode in the display panel according to one or more embodiments of the present disclosure.

FIG. 6 is another schematic top view of the first pixel electrode in the display panel according to one or more embodiments of the present disclosure.

FIG. 7 is yet another schematic top view of the first pixel electrode in the display panel according to one or more embodiments of the present disclosure.

FIG. 8 is a schematic top view of the second pixel electrode in the display panel according to one or more embodiments of the present disclosure.

FIG. 9 is another schematic top view of the second pixel electrode in the display panel according to one or more embodiments of the present disclosure.

FIG. 10 is yet another schematic top view of the second pixel electrode in the display panel according to one or more embodiments of the present disclosure.

FIG. 11 is another schematic top view of the display panel according to one or more embodiments of the present disclosure.

FIG. 12 is a schematic top view of the opposed substrate corresponding to FIG. 11.

FIG. 13 is a schematic top view of the array substrate corresponding to FIG. 11.

### DETAILED DESCRIPTION

The technical solutions in the embodiments of the present disclosure will be clearly and completely described with reference to the accompanying drawings. It should be appreciated that the described embodiments are only some of the embodiments of the present disclosure, but not all of them. Based on the embodiments of the present disclosure, all other embodiments obtained by those skilled in the art without involving any creative labor are within the scope of the present disclosure. Furthermore, it should be understood that the specific embodiments described herein are only for the purpose of illustration and explanation of the present disclosure, and are not intended to limit the present disclosure. In the present disclosure, embodiments may be combined with each other but will not be redundantly described. Unless otherwise specified, directional terms such as “above” and “below” generally refer to directions of a device in its actual operation or working state, specifically the direction shown in the accompanying drawings; “inside” and “outside” refer to the outline of the device; and terms like “first”, “second”, and “third”, etc. are merely used as labels and do not impose numerical requirements or establish order.

In the relevant display panels of the FFS display mode, the transmissive areas of a red sub-pixel, a green sub-pixel, and a blue sub-pixel are equal. When Δnd≤340 nm, there will be a bluish appearance on the white picture of the display panel. Specific details can refer to the following table, which shows the white point simulation results with different Δnd values. The coordinates of the standard white point are Wx, Wy (0.313, 0.329), where Δnd represents the multiplication result of the birefringence (Δn) of the liquid crystal molecules and the thickness (d) of the liquid crystal layer.

| Δnd(nm) | 200 | 220 | 240 | 260 | 280 | 300 | 320 | 340 | 360 |
|---|---|---|---|---|---|---|---|---|---|
| Wx | 0.265 | 0.271 | 0.277 | 0.283 | 0.289 | 0.295 | 0.301 | 0.307 | 0.313 |
| Wy | 0.281 | 0.287 | 0.293 | 0.299 | 0.305 | 0.311 | 0.317 | 0.323 | 0.329 |

As the Δnd decreases, the bluish appearance will be stronger. Given that the transmittance of the sub-pixel in blue among the three primary colors is the lowest, the overall transmittance of the display panel will be decreased as the Δnd decreases.

An approach of the embodiments of the present disclosure is to reduce the transmissive area of the blue sub-pixel and increase that of the red sub-pixel and/or green sub-pixel under the condition of the pixel area remaining unchanged; or to reduce the transmissive area of the blue sub-pixel while keeping the aperture area corresponding to the blue sub-pixel unchanged, thereby reducing the risk of the bluish appearance on the white picture so as to approach or achieve the standard white point and meanwhile enhance the overall transmittance of the display panel.

Additionally, the stronger the bluish appearance, the larger the corresponding decrease in the transmissive area of the blue sub-pixel, in order to match the standard white point.

One or more embodiments of the present disclosure provide a display panel, which will be detailed described below. It should be noted that the order of description of the following embodiments is not intended to limit the preferred order of embodiments.

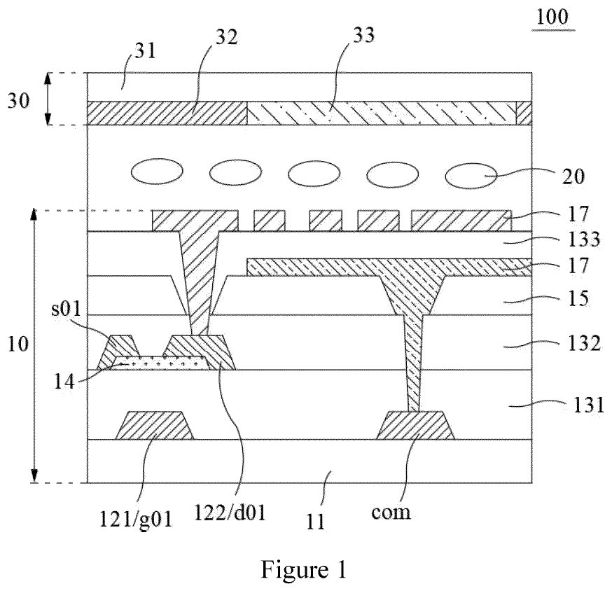

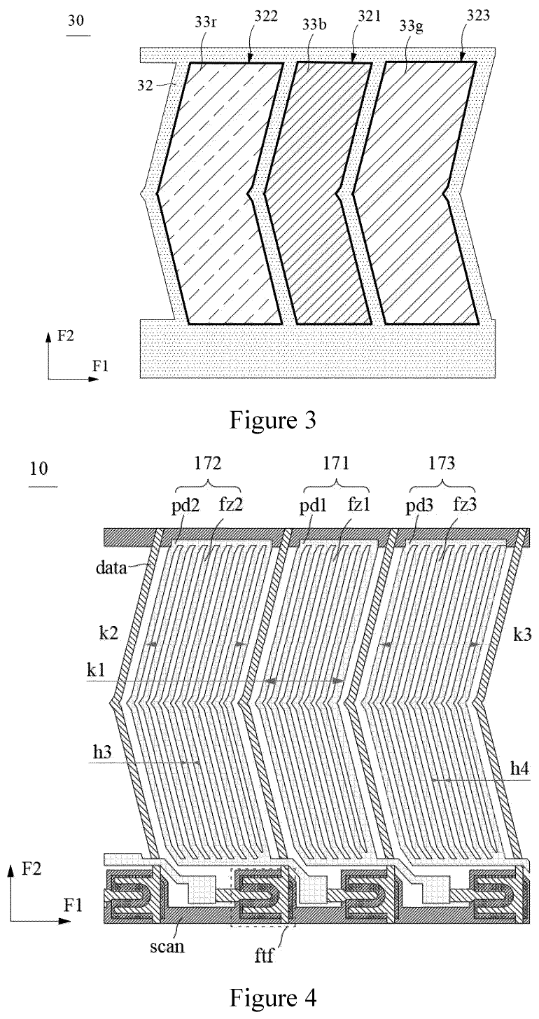

As shown in FIGS. 1 to 4, the display panel 100 according to the embodiments, can be a display panel in FFS mode. The following description will use the display panel 100 in FFS mode as an example, but the embodiments are not limited to this. For instance, besides FFS mode, the display panel 100 can also be in an IPS (In-Plane Switching) mode, in a VA (Vertical Alignment) mode, or in a TN (Twisted Nematic) mode. The detailed embodiments will be explained below with reference to the accompanying drawings.

One or more embodiments of the present disclosure provide a display panel 100, which includes an array substrate 10, a liquid crystal layer 20, and an opposed substrate 30 that are arranged sequentially.

Optionally, the array substrate 10 is illustrated with an example without a color film layer 33, but it is not limited to this. For example, the color film layer 33 can also be integrated into the array substrate 10.

The array substrate 10 includes a first substrate 11, a first metal layer 121, a first insulating layer 131, an active layer 14, a second metal layer 122, a second insulating layer 132, a flat layer 15, a common electrode 16, a third insulating layer 133, and a pixel electrode 17 arranged in sequence.

The first metal layer 121 is disposed on the first substrate 11 and includes a gate g01, a scanning line (scan), and a common wiring (com). The first insulating layer 131 covers the first metal layer 121. The active layer 14 is disposed on the first insulating layer 131. The second metal layer 122 is disposed on the active layer 14, and the second metal layer 122 includes a source s01, a drain d01, and a data line (data). The source s01 and the drain d01 are connected to the active layer 14. The second insulating layer 132 covers the second metal layer 122. The flat layer 15 covers the side of the second insulating layer 132 away from the first substrate 11. The common electrode 16 is disposed on the flat layer 15. The third insulating layer 133 covers the common electrode 16. The pixel electrode 17 is disposed on the third insulating layer 133.

Herein, the common electrode 16 and the pixel electrode 17 are configured to access different voltages to create an electric field to drive deflection of liquid crystals.

Optionally, in the top view of the display panel 100, a plurality of scanning lines (scan) and a plurality of data lines (data) intersect to form a plurality of pixel areas. One pixel electrode 17 is disposed within one pixel area.

The display panel 100 also includes a thin film transistor (TFT). One pixel electrode 17 is connected to one thin film transistor (TFT) correspondingly. The data line (data) is connected to the source s01 of the thin film transistor (TFT), the scanning line (scan) is connected to the gate g01 of the thin film transistor (TFT), and the pixel electrode 17 is connected to the drain d01 of the thin film transistor (TFT).

Optionally, the pixel electrode 17 includes a first pixel electrode 171, a second pixel electrode 172, and a third pixel electrode 173. The first pixel electrode 171 is configured to correspond to a blue sub-pixel 33b, the second pixel electrode 172 is configured to correspond to a red sub-pixel 33r, and the third pixel electrode 173 is configured to correspond to a green sub-pixel 33g.

It should be understood that the layer positions of the common electrode 16 and the pixel electrode 17 are not limited to the configurations above, as long as the common electrode 16 and the pixel electrode 17 are arranged in different layers. Additionally, the structure of the thin film transistor is not limited to a bottom-gate type. It can be a top-gate type, a double-gate type, or a vertical type, etc. The layer positions of the scanning line (scan) and the data line (data) are also not limited, as long as they do not short-circuit.

Optionally, the materials of the common electrode 16 and the pixel electrode 17 are transparent conductive materials. For example, the transparent conductive materials can include indium tin oxide, indium zinc oxide, and so on.

Optionally, the opposed substrate 30 includes a second substrate 31, a black matrix layer 32, and a color film layer 33. The black matrix layer 32 is disposed on the side of the second substrate 31 closed to the liquid crystal layer 20. A plurality of openings are formed on the black matrix layer 32. Each opening corresponds to a pixel electrode 17. The plurality of openings include a first opening 321, a second opening 322, and a third opening 323. The first opening 321 corresponds to the first pixel electrode 171, the second opening 322 corresponds to the second pixel electrode 172, and the third opening 323 corresponds to the third pixel electrode 173.

The color film layer 33 includes a plurality of sub-pixels. Each sub-pixel is correspondingly arranged in one opening. The plurality of sub-pixels include red sub-pixel 33r, green sub-pixel 33g, and blue sub-pixel 33b.

The blue sub-pixel 33b fully covers the first opening 321, and the blue sub-pixel 33b covers the first pixel electrode 171. The red sub-pixel 33r fully covers the second opening 322, and the red sub-pixel 33r covers the second pixel electrode 172. The green sub-pixel 33g fully covers the third opening 323, and the green sub-pixel 33g covers the third pixel electrode 173.

Optionally, the materials of the color film layer 33 can be color-resistant materials, but is not limited to this. For example, the materials can also be materials of quantum dots or other color-filtering materials.

Optionally, the transmittance of the blue sub-pixel 33b is lower than the transmittance of the red sub-pixel 33r and the transmittance of the green sub-pixel 33g. An average transmissive area is defined as an average value of the sum of the transmissive areas of one blue sub-pixel 33b, one red sub-pixel 33r, and one green sub-pixel 33g.

When Δnd≤340 nm, the transmissive area of the blue sub-pixel 33b is less than the average transmissive area. The transmissive area of the red sub-pixel 33r is greater than or equal to the average transmissive area. The transmissive area of the green sub-pixel 33g is greater than or equal to the average transmissive area. The sum of the transmissive areas of one red sub-pixel 33r and one green sub-pixel 33g is more than twice the average transmissive area. In other words, the transmissive area of the blue sub-pixel 33b is less than the average transmissive area. The transmissive area of the red sub-pixel 33r is greater than or equal to the average transmissive area. The transmissive area of the green sub-pixel 33g is greater than or equal to the average transmissive area. The transmissive area of the red sub-pixel 33r and the transmissive area of the green sub-pixel 33g are not simultaneously equal to the average transmissive area.

It should be noted that, compared to the prior art where the transmissive areas of the red, green, and blue sub-pixels are equal, the approach of the embodiments in the present disclosure is to reduce the transmissive area of the blue sub-pixel 33b while increasing the transmissive area of the red sub-pixel 33r and/or the transmissive area of the green sub-pixel 33g, thereby reducing the risk of a bluish appearance in the white picture so as to approach or achieve the standard white point and meanwhile enhance the overall transmittance of the display panel 100.

For example, in the prior art, the transmissive area of each of the red sub-pixel, the green sub-pixel, and the blue sub-pixel is M, then the average transmissive area of them is M.

On the basis that the sum of the transmissive areas of the red, green, and blue sub-pixels remains unchanged, the transmissive area of the blue sub-pixel 33b is less than the average transmissive area M, which means that the transmissive area of the blue sub-pixel 33b and also the proportion of the blue sub-pixel 33b are reduced.

The transmissive areas of the red sub-pixel 33r and the transmissive area of the green sub-pixel 33g are respectively greater than or equal to the average transmissive area M. The sum of the transmissive areas of one red sub-pixel 33r and one green sub-pixel 33g is greater than twice the average transmissive area M. This means that the proportion of the transmissive area of the red sub-pixel 33r can be improved by increasing the transmissive area of the red sub-pixel 33r while keeping the transmissive area of the green sub-pixel 33g unchanged. Alternatively, the proportion of the transmissive area of the green sub-pixel 33g can be improved by increasing the transmissive area of the green sub-pixel 33g while keeping the transmissive area of the red sub-pixel 33r unchanged. Also alternatively, the proportions of the transmissive areas of both the red sub-pixel 33r and green sub-pixel 33g can be improved by increasing their transmissive areas simultaneously.

It can be understood that as the transmissive area of the blue sub-pixel 33b reduces, an output amount of blue light will decrease, thereby reducing the risk of the bluish appearance on the white picture. On the other hand, since the transmittance of the blue sub-pixel 33b is lower than that of the red sub-pixel 33r and that of the green sub-pixel 33g, that is, the output amount of red and/or green light in a unit of transmissive area is greater than that of blue light, the transmissive area of the blue sub-pixel 33b decreases and meanwhile the transmissive areas of the red sub-pixel 33r and/or the green sub-pixel 33g increase, thereby increasing the output amount of red and/or green light and improving the overall transmittance of the display panel 100. At the same time, the increase of the amount of red and/or green light is tolerance for mixing more blue light, which can further reduce the risk of the bluish appearance on the white picture.

Optionally, in some embodiments of the present disclosure, the transmissive area of the red sub-pixel 33r and the transmissive area of the transmissive area of the green sub-pixel 33g are greater than the average transmissive area respectively. That is an approach of reducing the risk of the bluish appearance on the white picture and enhancing the overall transmittance of the display panel 100 by simultaneously increasing the transmissive area of the red sub-pixel 33r and the transmissive area of the green sub-pixel 33g.

Additionally, compared to the case that only either of the transmissive area of the red sub-pixel 33r and the transmissive area of the green sub-pixel 33g is increased, increasing the transmissive area of the red sub-pixel 33r and the transmissive area of the green sub-pixel 33g simultaneously can form the white light in a manner of more evenly blending the light, so as to achieve the standard white point in a better way and reduce the risk of color shift in side vision.

Optionally, in some embodiments of the present disclosure, the transmissive area of the red sub-pixel 33r is equal to the transmissive area of the green sub-pixel 33g so as to improve the symmetry between the left and right viewing angles.

Optionally, in some embodiments of the present disclosure, in the top view of the display panel 100, the blue sub-pixel 33b covers the first pixel electrode 171, one of the red sub-pixel 33r and the green sub-pixel 33g covers the second pixel electrode 172, and the other of the red sub-pixel 33r and the green sub-pixel 33g covers the third pixel electrode 173.

In a first direction F1 parallel to the scanning line (scan), the width k1 of the first pixel electrode 171 is less than the width k2 of the second pixel electrode 172.

Optionally, in some embodiments of the present disclosure, in the first direction parallel to the scanning line (scan), the width k1 of the first pixel electrode 171 is less than the width k3 of the third pixel electrode 173.

It should be noted that the situation of the red sub-pixel 33r covering the second pixel electrode 172 and the green sub-pixel 33g covering the third pixel electrode 173 is indicated as an example of the present disclosure, but it is not limited to this. For instance, the red sub-pixel 33r can cover the third pixel electrode 173, and the green sub-pixel 33g can cover the second pixel electrode 172.

Based on the correspondence between the pixel electrodes 17 and the sub-pixels, the width of the blue sub-pixel 33b is less than that of the red sub-pixel 33r and that of the green sub-pixel 33g in the first direction F1 parallel to the scanning line respectively.

Optionally, an average value of the sum of widths of the first pixel electrode 171, the second pixel electrode 172, and the third pixel electrode 173 is defined as an average width. The width of the first pixel electrode 171 is less than the average width; the width of the second pixel electrode 172 is greater than the average width; and/or the width of the third pixel electrode 173 is greater than the average width.

In the display panel 100 according to the embodiments of the present disclosure, the transmissive area of the blue sub-pixel 33b is reduced by decreasing the width k1 of the first pixel electrode 171, and the transmissive area of the red sub-pixel 33r and/or the transmissive area of green sub-pixel 33g is increased by increasing the width k2 of the second pixel electrode 172 and/or the width k3 of the third pixel electrode 173.

Optionally, in some embodiments of the present disclosure, the first pixel electrode 171 includes a first edge electrode pb1 and a plurality of first branch electrodes fz1. The plurality of first branch electrodes fz1 are connected to the first edge electrode pb1, and arranged spaced apart along the first direction F1.

The second pixel electrode 172 includes a second edge electrode pb2 and a plurality of second branch electrodes fz2. The plurality of second branch electrodes fz2 are connected to the second edge electrode pb2, and arranged spaced apart along the first direction F1.

The third pixel electrode 173 includes a third edge electrode pb3 and a plurality of third branch electrodes fz3. The plurality of third branch electrodes fz3 are connected to the third edge electrode pb3, and arranged spaced apart along the first direction F1.

Optionally, in some embodiments of the present disclosure, the number of the first branch electrodes fz1 is less than the number of the second branch electrodes fz2; and/or the number of the first branch electrodes fz1 is less than the number of the third branch electrodes fz3.

Optionally, an average of the sum of the numbers of the first branch electrodes fz1 of the first pixel electrode 171, the second branch electrodes fz2 of the second pixel electrode 172, and the third branch electrodes fz3 of the third pixel electrode 173 is defined as an average number. The number of the first branch electrodes fz1 of the first pixel electrode 171 is less than the average number, the number of the second branch electrodes fz2 of the second pixel electrode 172 is greater than the average number, and/or the number of the third branch electrodes fz3 of the third pixel electrode 173 is greater than the average number.

In the display panel 100 according to the embodiments of the present disclosure, the transmissive area of the blue sub-pixel 33b is reduced by reducing the number of the first branch electrodes fz1 of the first pixel electrode 171; and the transmissive area of the red sub-pixel 33r and/or the transmissive area of the green sub-pixel 33g is increased by increasing the number of second branch electrodes fz2 of the second pixel electrode 172 and/or the number of third branch electrodes fz3 of the third pixel electrode 173.

As shown in FIGS. 4 to 7, optionally, in some embodiments of the present disclosure, the plurality of first branch electrodes fz1 include a first portion of the first branch electrodes fz1 and a second portion of the first branch electrodes fz1. The second portion of the first branch electrodes fz1 is located on at least one side of the first portion of the first branch electrodes fz1. In the first portion of the first branch electrodes fz1, a first spacing h1 is provided between two adjacent first branch electrodes fz1. In the second portion of the first branch electrodes fz1, a second spacing h2 is provided between two adjacent first branch electrodes fz1. The first spacing h1 is less than the second spacing h2. A third spacing h3 is provided between any two adjacent second branch electrodes fz2. The second spacing h2 is less than or equal to the third spacing h3.

It can be understood that, the transmissive area of the blue sub-pixel 33b can be further reduced by narrowing the spacing (the first spacing h1 and/or the second spacing h2) between some of the first branch electrodes fz1 in the first pixel electrode 171; and the transmissive area of the red sub-pixel 33r can be increased by enlarging the spacing (the third spacing h3) between the second branch electrodes fz2 in the second pixel electrode 172.

Additionally, it should be noted that based on the driving method of FFS mode, narrowing the first spacing h1 and/or the second spacing h2 between the first branch electrodes fz1 will increase an electric field force applied on the liquid crystal molecules in the slit area corresponding to the first spacing h1, thereby enhancing the liquid crystal response speed and transmittance in the area.

Therefore, as the first spacing h1 and/or the second spacing h2 are narrowed, the transmissive area of the blue sub-pixel 33b also decreases correspondingly. Then, for two blue sub-pixels 33b respectively having the same area, the blue sub-pixel 33b corresponding to the first pixel electrode 171 with the relatively small spacing between the first branch electrodes fz1 has a relatively high transmittance. Therefore, in some embodiments of the present disclosure, which is on the basis of the above embodiments, the white picture can be fine-tuned by narrowing the first spacing h1 and/or the second spacing h2, so as to reduce white point variation.

In some embodiments of the present disclosure, the plurality of third branch electrodes fz3 are arranged spaced apart along the first direction F1. A fourth spacing h4 is provided between any two adjacent third branch electrodes fz3. The second spacing h2 is less than or equal to the fourth spacing h4.

It is understood that the transmissive area of the green sub-pixel 33g can be improved by increasing the spacing (the fourth spacing h4) between the third branch electrodes fz3 in the third pixel electrode 173.

In some embodiments of the present disclosure, the third spacing h3 is equal to the fourth spacing h4, so that the second branch electrodes fz2 are arranged at the spacing, at which the third branch electrodes fz3 are arranged, thereby improving the symmetry between the left and right viewing angles.

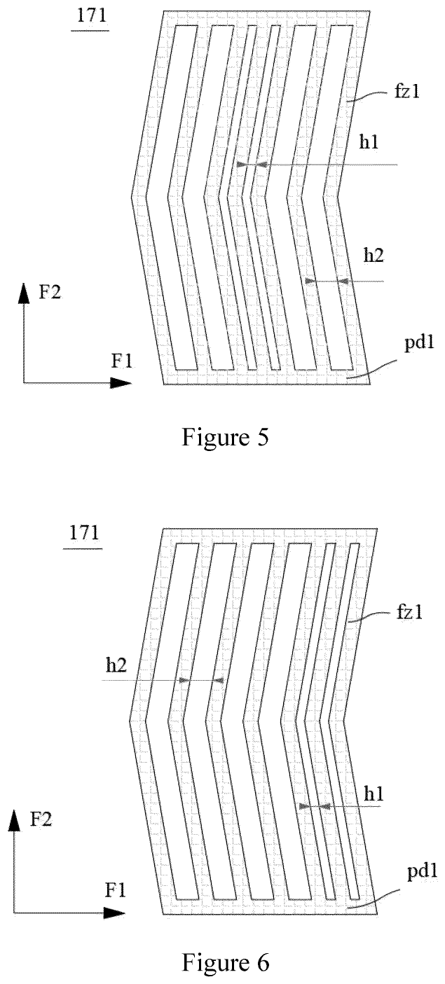

Optionally, in some embodiments of the present disclosure, the second portion of the first branch electrodes fz1 are located on opposite sides of the first portion of the first branch electrodes fz1, as shown in FIG. 5.

It is understood that the second portion of the first branch electrodes fz1 are arranged on both sides of the first portion of the first branch electrodes fz1 to improve the symmetry between the left and right viewing angles.

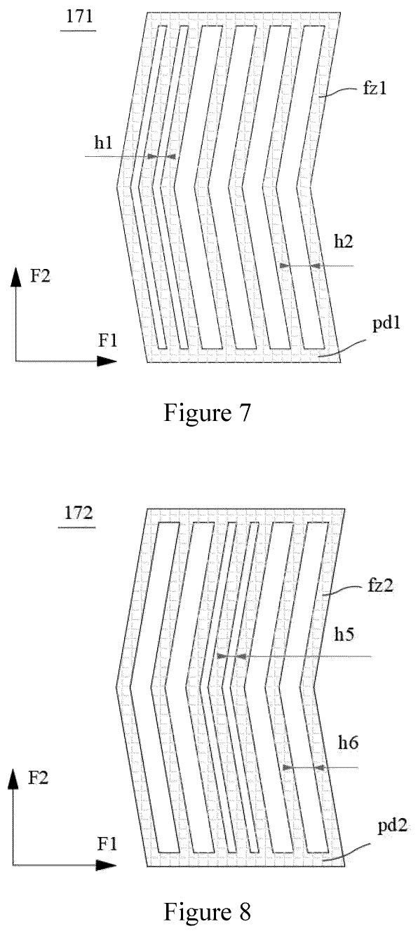

Optionally, in some embodiments of the present disclosure, the second portion of the first branch electrodes fz1 are located on one side of the first portion of the first branch electrodes fz1. For example, the second portion of the first branch electrodes fz1 can be located on the left side of the first portion of the first branch electrodes fz1, as shown in FIG. 6; or on the right side, as shown in FIG. 7.

It should be understood that the display panel 100 corresponding to the embodiments shown in FIG. 6 or FIG. 7 can be cooperated with an alignment film to improve the asymmetry between the left and right viewing angles.

Please refer to FIGS. 8 to 10. Compared to the embodiments corresponding to FIGS. 4 to 7, the embodiments corresponding to FIGS. 8 to 10 adjust the spacing of branch electrodes of at least one of the second pixel electrode 172 and the third pixel electrode 173 so as to increase the light output amount of at least one color light of red and green, thereby adjusting the white point coordinates.

The different parts of the embodiments shown in FIGS. 4 to 7 will be described below to avoid redundant explanations. The following is an example of adjusting the second pixel electrode 172 corresponding to the red sub-pixel 33r, but is not limited to this. For instance, the second pixel electrode 172 can also correspond to the green sub-pixel 33g.

Optionally, in some embodiments of the present disclosure, a fifth spacing h5 is provided between any two adjacent first branch electrodes fz1 in the first pixel electrode 171.

In the second pixel electrode 172, a plurality of second branch electrodes fz2 include the first portion of the second branch electrodes fz2 and the second portion of the second branch electrodes fz2. The second portion of the second branch electrodes fz2 is located on at least one side of the first portion of the second branch electrodes fz2. In the first portion of the second branch electrodes fz2, a sixth spacing h6 is provided between two adjacent second branch electrodes fz2. In the second portion of the second branch electrodes fz2, a seventh spacing h7 is provided between two adjacent second branch electrodes fz2. The sixth spacing h6 is less than the seventh spacing h7.

The seventh spacing h7 is less than or equal to the fifth spacing h5.

It should be understood that for two red sub-pixels 33r respectively having the same area, the red sub-pixel 33r corresponding to the second pixel electrode 172 with the relatively small spacing between the second branch electrodes fz2 has a relatively high transmittance. Therefore, in some embodiments of the present disclosure, the white picture can be fine-tuned by narrowing the sixth spacing h6 and/or the seventh spacing h7 to increase the output amount of red light, thereby reducing white point variation.

Additionally, adjusting the spacing between the second branch electrodes fz2 of the second pixel electrode 172 can improve the symmetry between the left and right viewing angles of the display panel 100.

For example, as shown in FIG. 8, the second portion of the second branch electrodes fz2 is located on opposite sides of the first portion of the second branch electrodes fz2, thereby increasing the symmetry between the left and right viewing angles.

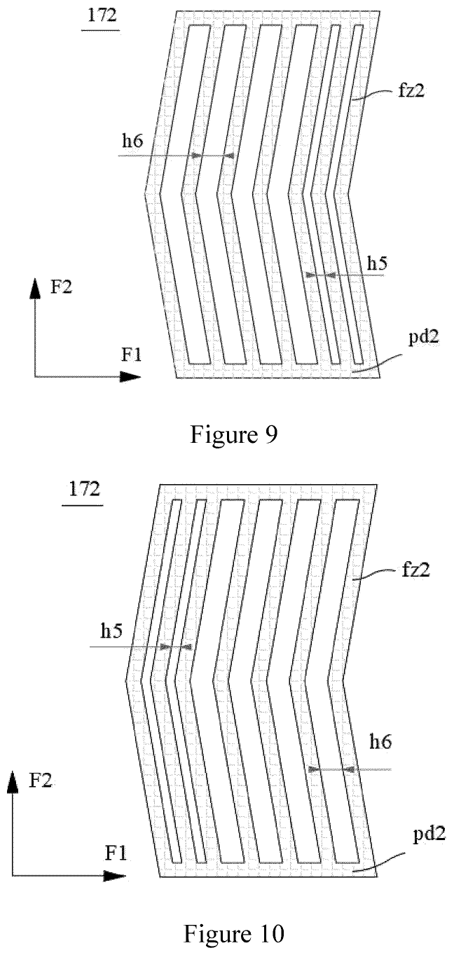

Additionally, as shown in FIG. 9, the second portion of the second branch electrodes fz2 is located on the left side of the first portion of the second branch electrodes fz2. Also as shown in FIG. 10, the second portion of the second branch electrodes fz2 is located on the right side of the first portion of the second branch electrodes fz2. It should be understood that the display panel 100 corresponding to the embodiments shown in FIG. 9 or FIG. 10 can be cooperated with an alignment film to improve the problem of asymmetry between the left and right viewing angles.

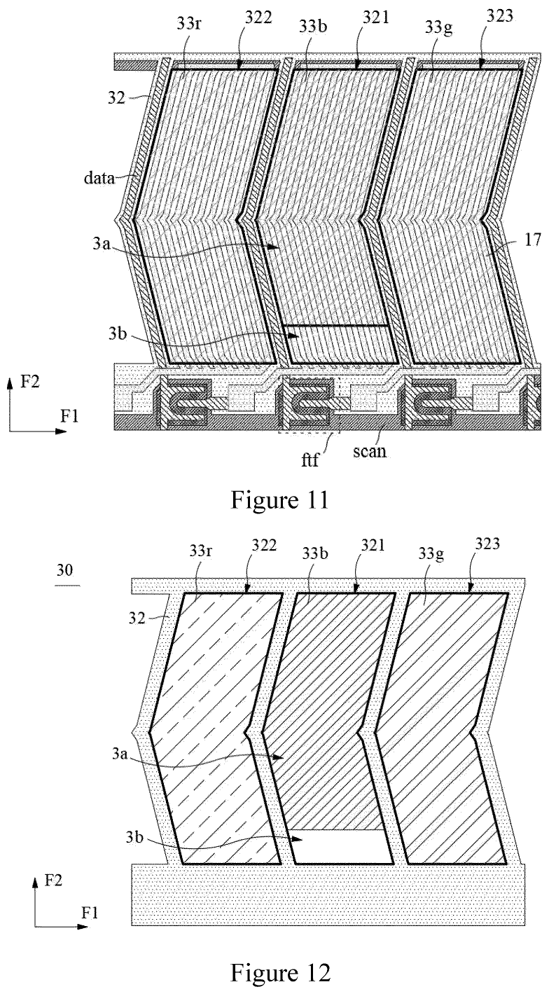

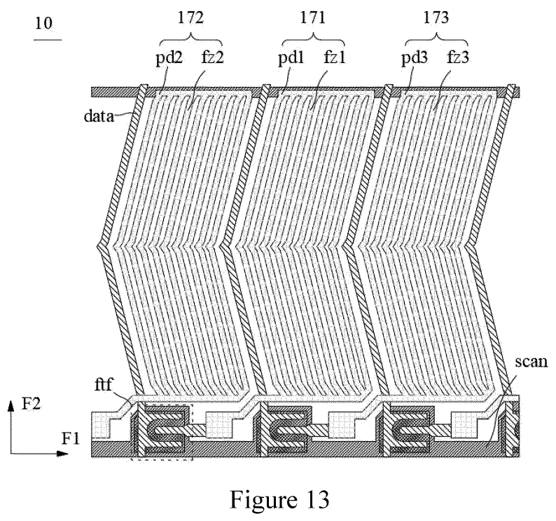

Please refer to FIGS. 11 to 13. FIG. 11 shows another schematic top view of the display panel 100 according to an embodiment of the present disclosure. FIG. 12 shows a schematic top view of the opposed substrate 30 corresponding to FIG. 11. And FIG. 13 shows a schematic top view of the array substrate 10 corresponding to FIG. 11.

In FIGS. 11 to 13, the parts of the display panel 100 that differ from the above embodiments will be described, while the same parts will not be repeatedly described below.

Optionally, in some embodiments of the present disclosure, the display panel 100 further includes a black matrix layer 32. A first opening 321, a second opening 322, and a third opening 323 are formed on the black matrix layer 32. The first opening 321 includes a blue light area 3a and a white light area 3b. The blue sub-pixel 33b fully covers the blue light area 3a, while the white light area 3b is configured to transmit white light and does not includes a blue sub-pixel 33b. The red sub-pixel 33r fully covers the second opening 322. The green sub-pixel 33g fully covers the third opening 323.

In the display panel 100 according to the embodiments of the present disclosure, under the condition of the pixel area remaining unchanged, the transmissive area of the blue sub-pixel 33b is reduced. Furthermore, on the basis of keeping the aperture area (first opening 321) corresponding to the blue sub-pixel 33b unchanged, the transmissive area of the blue sub-pixel is reduced, and the white light area is increased, so that the risk of the bluish appearance on the white picture is reduced so as to approach or achieve the standard white point. Since the white light area 3b does not contain a blue sub-pixel 33b, the transmittance of the white light area 3b is greater than that of the green sub-pixel 33g, thereby allowing a portion of the backlight to be able to pass directly through the white light area 3b, thus improving the overall transmittance of the display panel.

It should be noted that, the total transmissive area of the second opening 322 corresponding to the red sub-pixel 33r, the third opening 323 corresponding to the green sub-pixel 33g, and the first opening 321 corresponding to the blue sub-pixel 33b remain unchanged. The transmissive area of the blue sub-pixel 33b is less than the average transmissive area. That means, the transmissive area of the blue sub-pixel 33b and the proportion of the blue sub-pixel 33b are reduced.

The transmissive area of the red sub-pixel 33r and the transmissive area of the green sub-pixel 33g are greater than or equal to the average transmissive area respectively. The sum of the transmissive area of one red sub-pixel 33r and the transmissive area of one green sub-pixel 33g is more than twice the average transmissive area. Thus, when the transmissive area of the blue sub-pixel 33b is reduced, the proportions of both the transmissive area of the red sub-pixel 33r and the transmissive area of the green sub-pixel 33g increase, thereby further improving the effect of light mixing so as to reduce the risk of a bluish appearance on white picture for approaching or achieving the standard white point.

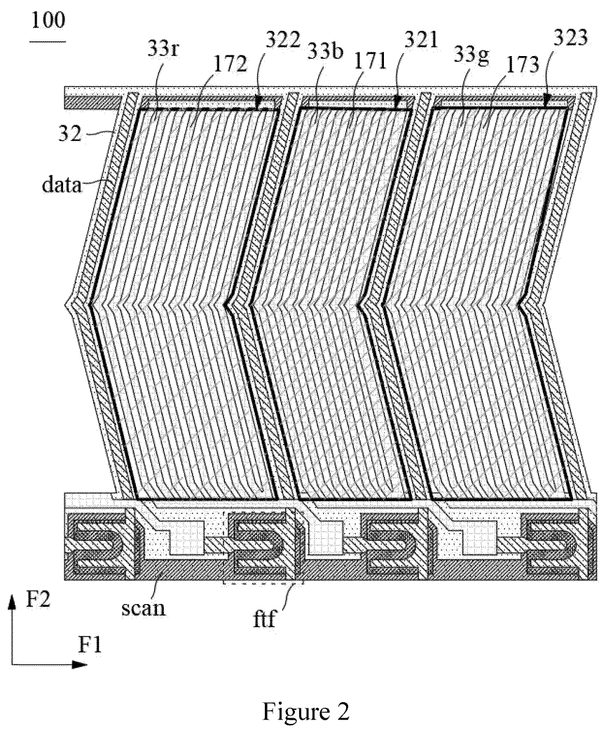

Compared to the embodiments corresponding to FIG. 2, the display panel 100 corresponding to FIG. 11 can be improved by simply removing some of the blue sub-pixels 33b, thereby making the improvement scheme relatively simple.

Optionally, in some embodiments of the present disclosure, the aperture area of the first opening 321, the aperture area of the second opening 322, and the aperture area of the third opening 323 are all equal.

Optionally, in some embodiments of the present disclosure, in a second direction F2 perpendicular to the extending direction of the scanning line (scan), the white light area 3b is located on one side of the blue light area 3a. This configuration ensures that in the first direction F1, the spacing from the blue sub-pixel 33b to the red sub-pixel 33r is the same as the spacing from the blue sub-pixel 33b to the green sub-pixel 33g, thereby reducing the risk of color shift at the left and right viewing angles.

In some embodiments, there can be a plurality of white light areas 3b. The plurality of white light areas 3b are uniformly arranged in the first opening 321 and extend in the depth direction of the first opening 31 through the blue sub-pixel 33b, thereby reducing the risks of asymmetry between the left and right viewing angles, asymmetry between the up and down viewing angles, and the occurrence of color shift.

It should be noted that, in the display panel 100 according to the embodiments corresponding to FIG. 11, the structure of the pixel electrodes 17 corresponding to the red sub-pixel 33r, the structure of the pixel electrodes 17 corresponding to the green sub-pixel 33g, and the structure of the pixel electrodes 17 corresponding to the blue sub-pixel 33b are the same.

In some embodiments, the spacing between the first branch electrodes fz1 of the first pixel electrode 171 can be adjusted to increase the density of the first branch electrodes fz1 within the blue light area 3a and the white light area 3b, so as to further reduce the risk of white point variation and increase the transmittance of the display panel 100. The first pixel electrode 171 shown in FIGS. 5 to 7 can be referred to as an example.

The above provides a detailed description to a display panel provided in the embodiments of the present disclosure. Specific examples have been used to illustrate the principles and embodiments of the present disclosure. The descriptions of the above embodiments are intended to assist in understanding the methods and core concepts of the present disclosure. Meanwhile, variations in specific implementations and present disclosure scopes based on the ideas of the present disclosure are to be expected. In summary, the content of the specification should not be construed as a limitation to the present disclosure.

What is claimed is:

1. A display panel, comprising an array substrate, a liquid crystal layer, and an opposed substrate arranged sequentially, wherein the display panel further comprises:
a color film layer comprising a red sub-pixel, a green sub-pixel, and a blue sub-pixel, wherein the transmittance of the blue sub-pixel is lower than the transmittance of the red sub-pixel and the transmittance of the green sub-pixels respectively, and an average transmissive area is defined as an average value of the sum of the transmissive area of one blue sub-pixel, the transmissive area of one red sub-pixel, and the transmissive area of one green sub-pixel;
wherein the transmissive area of the blue sub-pixel is less than the average transmissive area, the transmissive area of the red sub-pixel is greater than or equal to the average transmissive area, the transmissive area of the green sub-pixel is greater than or equal to the average transmissive area, and the transmissive area of the red sub-pixel and the transmissive area of the green sub-pixel are not simultaneously equal to the average transmissive area.

2. The display panel according to claim 1, wherein the opposed substrate comprises a black matrix layer, a first opening, a second opening, and a third opening are formed on the black matrix layer, the blue sub-pixel fully covers the first opening, the red sub-pixel fully covers the second opening, and the green sub-pixel fully covers the third opening.

3. The display panel according to claim 2, wherein the transmissive area of the red sub-pixel and the transmissive area of the green sub-pixel are both larger than the average transmissive area.

4. The display panel according to claim 2, wherein the array substrate comprises a scanning line, a first pixel electrode, a second pixel electrode, and a third pixel electrode, in a top view of the display panel, the blue sub-pixel covers the first pixel electrode, one of the red sub-pixel and the green sub-pixel covers the second pixel electrode, and the other one of the red sub-pixel and the green sub-pixel covers the third pixel electrode;
in a first direction parallel to the scanning line, the width of the first pixel electrode is less than the width of the second pixel electrode.

5. The display panel according to claim 4, wherein the array substrate further comprises a common electrode, the first pixel electrode comprises a first edge electrode and a plurality of first branch electrodes, the plurality of first branch electrodes are connected to the first edge electrode and arranged spaced apart along a first direction;
the second pixel electrode comprises a second edge electrode and a plurality of second branch electrodes, the plurality of second branch electrodes are connected to the second edge electrode and arranged spaced apart along the first direction; and
the number of the first branch electrodes is less than the number of the second branch electrodes.

6. The display panel according to claim 5, wherein the width of the first pixel electrode is less than the width of the third pixel electrode along the first direction parallel to the scanning line.

7. The display panel according to claim 6, wherein the third pixel electrode comprises a third edge electrode and a plurality of third branch electrodes, the plurality of third branch electrodes are connected to the third edge electrode and arranged spaced apart along the first direction; and
the number of the first branch electrodes is less than the number of the third branch electrodes.

8. The display panel according to claim 4, wherein the array substrate further comprises a common electrode, the first pixel electrode comprises a first edge electrode and a plurality of first branch electrodes, the plurality of first branch electrodes are connected to the first edge electrode and arranged spaced apart along the first direction, the plurality of first branch electrodes comprise a first portion of the first branch electrodes and a second portion of the first branch electrodes, wherein the second portion of the first branch electrodes is located on at least one side of the first portion of the first branch electrodes; in the first portion of the first branch electrodes, a first spacing is provided between two adjacent first branch electrodes; in the second portion of the first branch electrodes, a second spacing is provided between two adjacent first branch electrodes, wherein the first spacing is less than the second spacing;
the second pixel electrode comprise a second edge electrode and a plurality of second branch electrodes, the second branch electrodes are connected to the second edge electrode, and arranged spaced apart along the first direction, a third spacing is provided between any two adjacent second branch electrodes; and
the second spacing is less than or equal to the third spacing.

9. The display panel according to claim 8, wherein the width of the first pixel electrode is less than the width of the third pixel electrode in the first direction parallel to the scanning line;
the third pixel electrode comprises a third edge electrode and a plurality of third branch electrodes, wherein the plurality of third branch electrodes are connected to the third edge electrode and arranged spaced apart along the first direction, and a fourth spacing is provided between any two adjacent third branch electrodes; and
the second spacing is less than or equal to the fourth spacing.

10. The display panel according to claim 8, wherein the second portion of the first branch electrodes is located on opposite sides of the first portion of the first branch electrodes; or
the second portion of the first branch electrodes is located on one side of the first portion of the first branch electrodes.

11. The display panel according to claim 4, wherein the array substrate further comprises a common electrode, the first pixel electrode comprises a first edge electrode and a plurality of first branch electrodes, the plurality of first branch electrodes are connected to the first edge electrode and arranged spaced apart along the first direction, and a fifth spacing is provided between any two adjacent first branch electrodes;
the second pixel electrode comprises a second edge electrode and a plurality of second branch electrodes, the plurality of second branch electrodes are connected to the second edge electrode, and arranged spaced apart along the first direction, the plurality of second branch electrodes comprise the second branch electrodes of a first portion and the second branch electrodes of a second portion, wherein the second portion of the second branch electrodes are located on at least one side of the first portion of the second branch electrodes; in the first portion of the second branch electrodes, a sixth spacing is provided between two adjacent second branch electrodes; in the second portion of the second branch electrodes, a seventh spacing is provided between two adjacent second branch electrodes, the sixth spacing is less than the seventh spacing; and
the seventh spacing is less than or equal to the fifth spacing.

12. The display panel according to claim 1, wherein the display panel further comprises a black matrix layer, a first opening, a second opening, and a third opening are formed on the black matrix layer, the first opening comprises a blue light area and a white light area, the blue sub-pixel fully covers the blue light area, the white light area is configured to transmit white light and does not includes blue sub-pixel, the red sub-pixel fully covers the second opening and the green sub-pixel fully covers the third opening.

13. The display panel according to claim 12, wherein the aperture area of the first opening, the aperture area of the second opening, and the aperture area of the third opening are equal.

14. The display panel according to claim 13, wherein in a second direction perpendicular to the extending direction of the scanning line, the white light area is located on one side of the blue light area.
